(19) United States
(12) Patent Application Publication
(10) Pub. No.: US 2026/0366929 A1
(43) Pub. Date: Nov. 19, 2026

(54) NEGATIVE THERMAL COEFFICIENT SENSOR ASSEMBLY WITH ASSOCIATED CAPACITOR

(71) Applicant: Amphenol Thermometrics, Inc., St. Marys, PA (US)

(72) Inventors: Bruno Antonio Cavalline, St. Marys, PA (US); David John Geer, Johnsonburg, PA (US)

(21) Appl. No.: 19/666,847

(22) Filed: May 4, 2026

Related U.S. Application Data
(60) Provisional application No. 63/805,474, filed on May 14, 2025.

(51) Int. Cl. G01K 7/22; G01K 1/02; G01K 1/14

(52) U.S. Cl. CPC G01K 7/22; G01K 1/026; G01K 1/14

(57) ABSTRACT

A sensor assembly includes: a lead frame comprising a foundation bar and a plurality of tines, the tines extending away from the foundation bar in a first direction; a plurality of sensors, each of the sensors including a thermistor and a pair of leads, each of the leads in electrical contact with a respective tine of the lead frame, wherein the tines in electrical contact with the leads are adjacent tines; a plurality of mounting blocks, each mounted to the lead frame to encase a pair of adjacent tines that are in electrical contact with the leads of one of the plurality of sensors, each of the mounting blocks including a pocket; and a plurality of electromagnet interference (EMI)-blocking components, each of the EMI-blocking components mounted in the pocket of a respective one of the mounting blocks and in electrical contact with the tines encased in the mounting block. Each of the mounting blocks includes one or more integral features within the pocket that mechanically capture the capacitive component.

### RELATED APPLICATION

The present application claims priority from and the benefit of U.S. Provisional Patent Application No. 63/805,474, filed May 14, 2025, the disclosure of which is hereby incorporated herein by reference in full.

### FIELD OF THE INVENTION

The present invention is directed generally to sensors, and more specifically to thermistor-based sensors.

### BACKGROUND

Thermistors are temperature-sensing elements made of semiconductor material that has been sintered in order to display large changes in resistance in proportion to small changes in temperature. This resistance can be measured by using a small and measured direct current (DC) passed through the thermistor in order to measure the voltage drop produced.

Negative Temperature Coefficient (NTC) thermistors are non-linear resistors, which alter their resistance characteristics with temperature. The resistance of NTC thermistors will decrease as the temperature increases. The manner in which the resistance decreases is related to a constant known in the electronics industry as beta, or ß (which is measured in °K).

Thermistors are often used in the automotive industry, especially in applications such as powertrain, safety and controls, and alternative fuel vehicles, due to the change in government standards and demand patterns from the end users. As one example, a total of 30 thermistors may be used in an automotive vehicle, which include 20 NTC sensors and five positive temperature coefficient (PTCs) sensors. Thermistors are currently a steady growing market and is expected to continue the same trend in coming years as well.

Thermistors may be sensitive to the presence of other electrical and electronic components in the nearby environment. As a result, in some applications a capacitor or other device that can protect the thermistor is included to ensure electromagnetic compatibility (EMC). It is common to include a capacitor in electrical contact with the thermistor to meet this requirement.

Given the number of NTCs that are currently in demand, it may be desirable to provide a technique for quickly and easily manufacturing assemblies that contain NTCs and that meet EMC requirements.

### SUMMARY

As a first aspect, embodiments of the invention are directed to a sensor assembly. The sensor assembly comprises: a lead frame comprising a foundation bar and a plurality of tines, the tines extending away from the foundation bar in a first direction; a plurality of sensors, each of the sensors including a thermistor and a pair of leads, each of the leads in electrical contact with a respective tine of the lead frame, wherein the tines in electrical contact with the leads are adjacent tines; a plurality of mounting blocks, each mounted to the lead frame to encase a pair of adjacent tines that are in electrical contact with the leads of one of the plurality of sensors, each of the mounting blocks including a pocket; and a plurality of electromagnet interference (EMI)-blocking components, each of the EMI-blocking components mounted in the pocket of a respective one of the mounting blocks and in electrical contact with the tines encased in the mounting block. Each of the mounting blocks includes one or more integral features within the pocket that mechanically capture the capacitive component.

As a second aspect, embodiments of the invention are directed to a method of forming a sensor assembly. The method includes the steps of:
(a) providing a lead frame comprising a foundation bar and a plurality of tines, the tines extending away from the foundation bar in a first direction;
(b) molding a mounting block onto the lead frame such that the mounting block encases a portion of two adjacent tines, wherein the mounting block includes a pocket and integral capture features in the pocket;
(c) attaching first and second leads of a sensor to the adjacent tines encased in the mounting blocks; and
(d) inserting an electromagnetic interference (EMI)-blocking component in a pocket in the mounting block, the EMI-blocking component captured by the capture features.

### BRIEF DESCRIPTION OF THE FIGURES

FIG. 1 is a perspective view of a sensor assembly according to embodiments of the invention.

FIG. 2 is a top view of three sensors of the assembly of FIG. 1.

FIG. 3 is a top view of the lead frame of the assembly of FIG. 1.

FIG. 4 is a perspective view of a thermistor-based sensor of the assembly of FIG. 1.

FIG. 5 is a view of the sensor of FIG. 4 with the covering removed.

FIG. 6 is an enlarged perspective view of the sensor of FIG. 4 attached to the lead frame of FIG. 3.

FIG. 7 is a top view of three sensors of FIG. 4 attached to adjacent forks of the lead frame of FIG. 3

FIG. 8 is a front perspective view of a mounting block of the assembly of FIG. 1.

FIG. 9 is a top perspective view of the mounting block of FIG. 8.

FIG. 10 is a bottom perspective view of the mounting block of FIG. 8.

FIG. 11 is a top perspective section view of the mounting block of FIG. 8.

FIG. 12 is a side perspective section view of the mounting block of FIG. 8.

FIG. 13 is a side perspective section view of the mounting block of FIG. 8 with the tines of and fingers of a fork of the lead frame of FIG. 3.

FIG. 14 is a greatly enlarged side section view of a capacitor mounted within a mounting block within the assembly of FIG. 1.

FIGS. 15A-15D illustrate steps in the manufacture of the assembly of FIG. 1.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

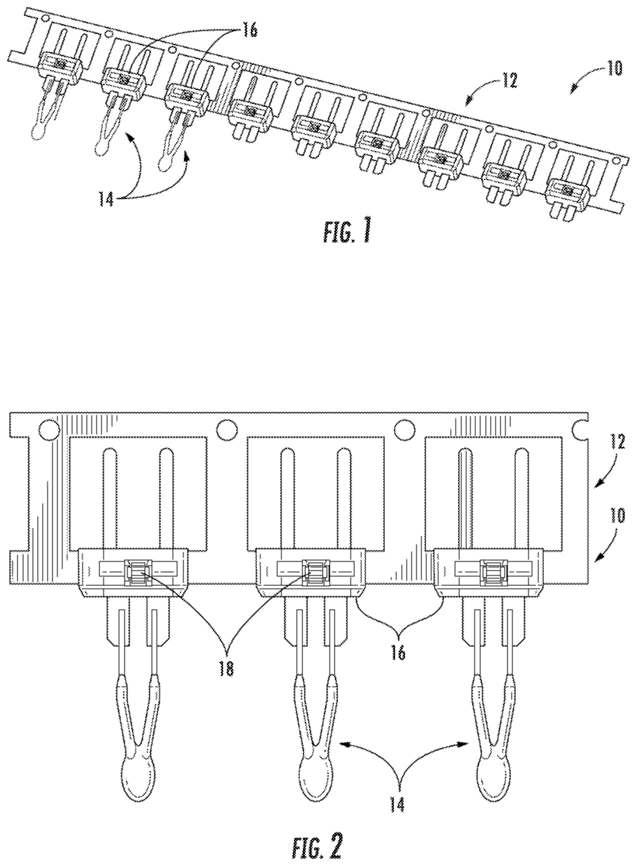

Referring now the drawings, a thermistor-based sensor assembly, designated broadly at 10, is shown in FIGS. 1 and 2. The assembly 10 includes a lead frame 12, a plurality of NTC sensors 14 (three are shown in FIG. 1), and a plurality of mounting blocks 16 for mounting the sensors 14 onto the lead frame 12 and for housing capacitors 18 (not visible in FIG. 1, but seen in FIG. 2) in electrical contact with the lead frame 12. These components are discussed in greater detail below.

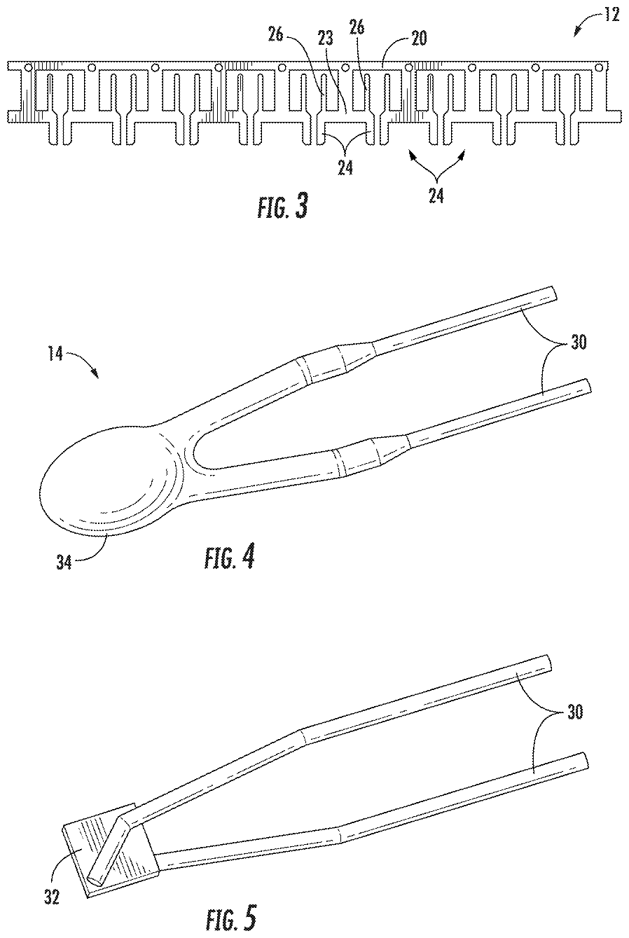

Referring now to FIG. 3, the lead frame 12 is shown therein. The lead frame 12 includes a foundation bar 20 and a plurality of forks 22, each of which includes one or more tines 24 extending from a cross-member 23. A finger 26 extends from the cross-member 23 generally opposite each of the tines 24. The forks 22 are positioned on the foundation bar 20 so that each tine 24 is located near, but spaced from, a tine 24 of an adjacent fork 22. The lead frame 12 is formed of a conductive material, typically constructed of ferrous or non-ferrous material such as 430 stainless steel, phosphor bronze, or brass.

Referring now to FIGS. 4 and 5, an exemplary NTC sensor 14 is shown therein. The sensor 14 includes two leads 30, each of which has one end that overlies a surface of a thermistor 32. In the illustrated embodiment an insulating material such as epoxy, phenolic, urethane or other conformal insulating material 34 protects the thermistor 32 and the ends of the leads 30. An exemplary NTC sensor is an NK or MS-style sensor, available from Amphenol Thermometrics.

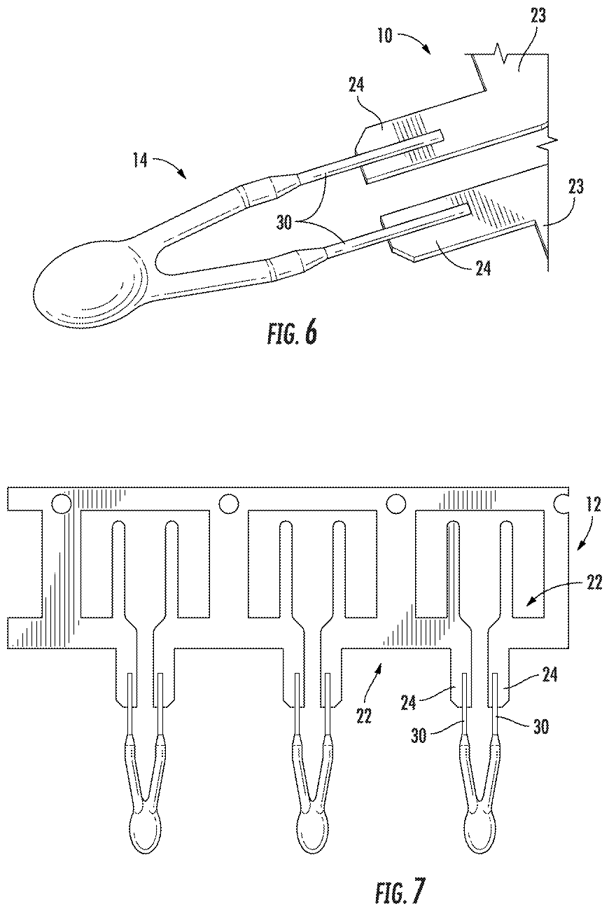

As shown in FIGS. 6 and 7, each of the sensors 14 is positioned in the assembly 10 so that each of the leads 30 overlies one of the tines 24 of the lead frame 12, with each lead 30 overlying one of the tines 24 of two adjacent forks 22.

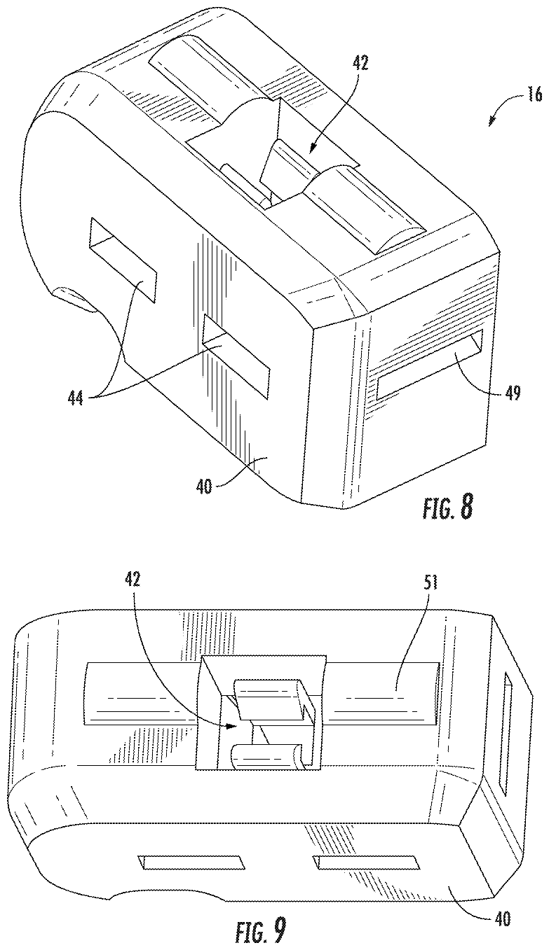

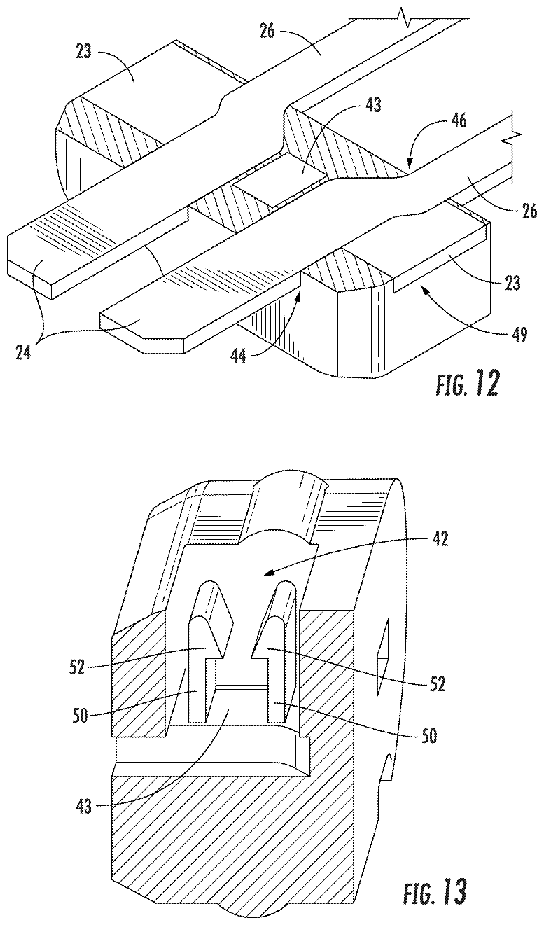

Referring now to FIGS. 8-12, each of mounting blocks 16 is generally rectangular, with the front edge 40 being beveled. A pocket 42 is present in the mounting block 16 and is open at its upper end; a passage 43 extends from the lower surface of the pocket 42 to the lower surface of the mounting block 16. Two slots 44 are present in the front surface of the mounting block 16, two windows 46 are present in the rear surface of the mounting block 16, and one slot 49 is present in each of the side surfaces of the mounting block 16. As seen in FIGS. 9 and 11, each slot 44 is contiguous with one of the windows 46 and one of the slots 49, and is also contiguous with the pocket 42. As seen in FIG. 12, on each side of the mounting block 16, the slot 44, the window 46, and the slot 49 are filled with portions of a tine 24, a finger 26 and a cross-member 23 of the lead frame 12.

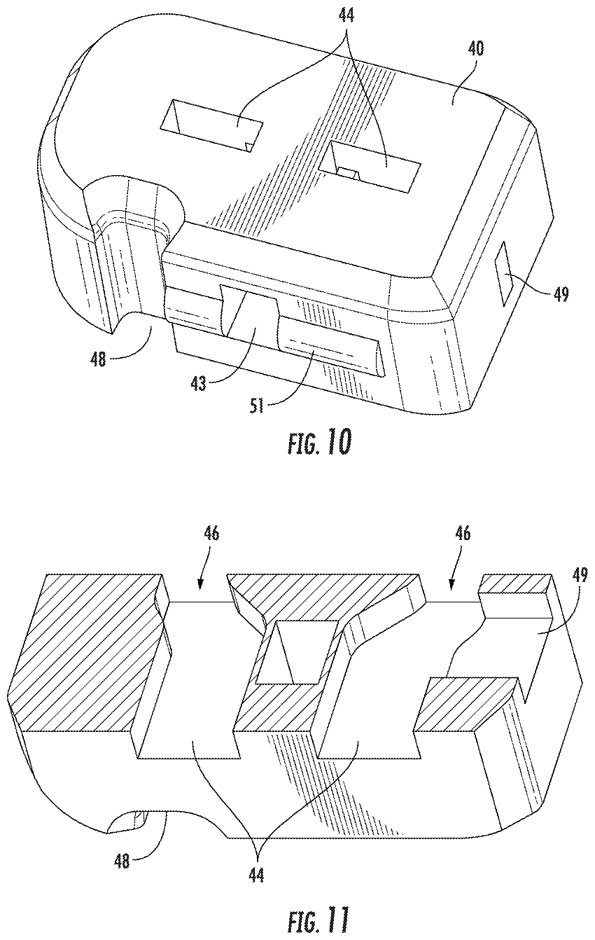

Referring now to FIG. 10, the mounting block 16 also includes a semi-oval recess 48 located in the lower surface of the mounting block 16. Discontinuous nubs 51 are located on the upper and lower surfaces of the mounting block 16.

As shown in FIG. 13, two snap-fit latches 50 are present in the pocket 42 of the mounting block 16. Each latch 50 extends upwardly from the lower surface of the pocket 42. A hook 52 is present on the free end of each latch 50; the hooks 52 of the two latches extend toward each other. Each latch 50 is positioned so that one face aligns with the edges of the passage 43.

The mounting blocks 16 are typically, but not exclusively, formed of a polymeric material, such as nylon, polyethylene or polypropylene.

Referring now to FIG. 14, a capacitor 18 is positioned within the pocket 42 of the mounting block 16. The capacitor 18 is generally rectangular and is held relatively snugly within the pocket 42 by the hooks 52 of the latches 50. The edges of the capacitor 18 overlie the adjacent edges of the tines 24 of the lead frame 12 that extend into the pocket 42. The capacitor 18 is adhered to the tines 24 by a conductive epoxy 56 or other conductive material (e.g., solder) so that the capacitor 18 is in electrical contact with the lead frame 12.

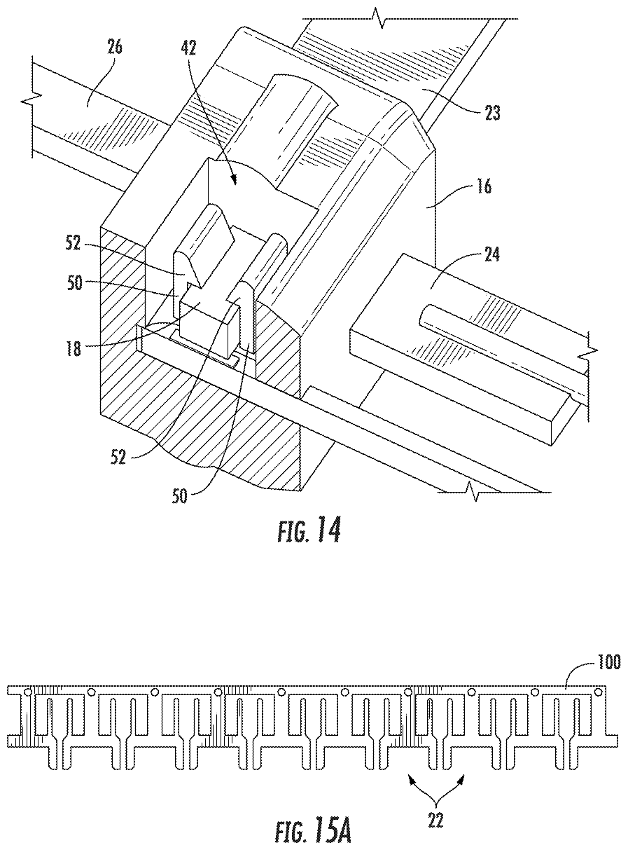

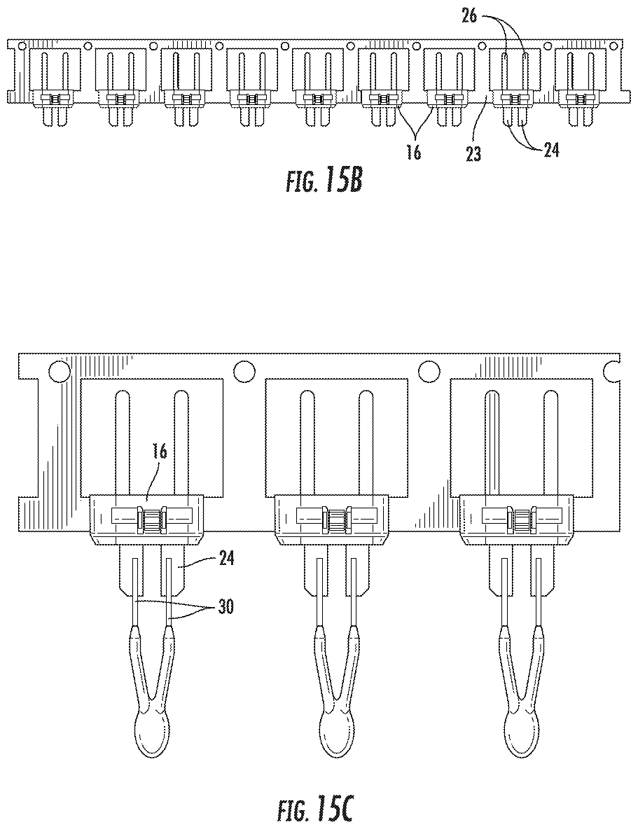

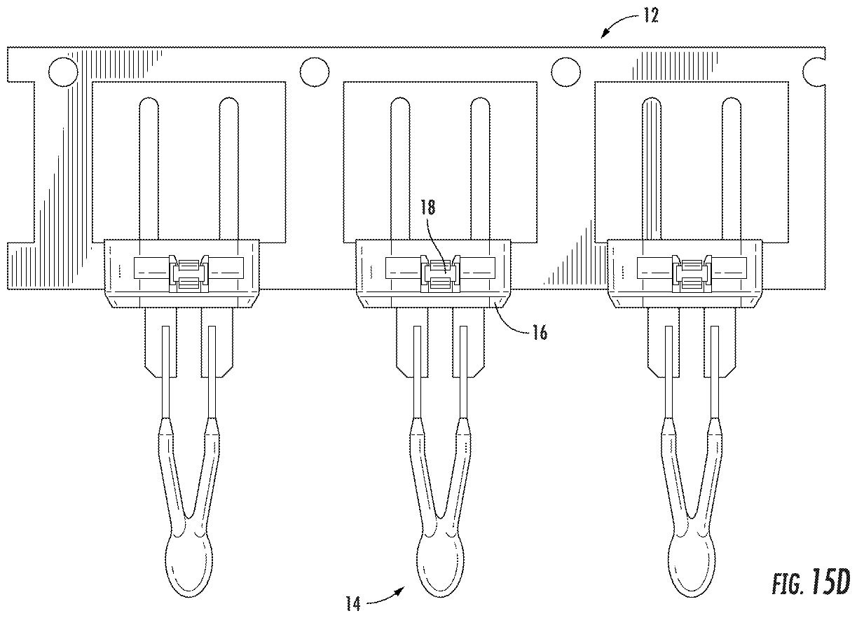

FIGS. 15A-15D illustrate a typical manufacturing operation for the assembly 10, which begins with a long strip 100 of a lead frame that includes dozens, if not hundreds, of forks 22 on a continuous foundation bar 20 (FIG. 15A). The strip 100 is conveyed to an injection mold, where a mounting block 16 is overmolded onto each pair of adjacent tines 24, fingers 26 and cross-members 23 of adjacent forks 22 (FIG. 15B). The strip 100 is advanced with each molding step (wherein one, two, three or more mounting blocks may be molded simultaneously), until the desired number of mounting blocks 16 is molded. The lead frame strip 100 with its mounting blocks 16 is then advanced to a station where the leads 30 of the sensor 14 are attached to the free ends of the tines 24 (typically via soldering or welding) (see FIG. 15C). Finally, the lead frame strip 100 is advanced to a station where the capacitor 18 is placed (e.g., by a robotic arm) between the latches 50 and into the pocket 42, such that the latches 50 capture and retain the capacitor 18 (see FIG. 15D). The capacitor 18 is adhered to the tines 24 via conductive epoxy, solder or the like as described above, which may be applied before, during, or after the placement of the capacitor 18. The lead frame strip 100 can then be cut to length to produce the assembly 10.

Those of skill in this art will appreciate that the assembly 10 may take different forms. As one example, the capacitor 18 may be captured in the pocket of the mounting block 16 by a different technique or by different integral features. As one example, only one latch may be employed (in some embodiments having a more prominent hook), with a solid wall replacing the other latch to help to capture the capacitor 18. In another example, the latches may be absent, and the walls of the pocket 42 may be closer together so that the capacitor 18 is held in an interference or friction fit (in such an instance, the walls of the pocket 42 may be tapered to facilitate insertion of the capacitor 18). Other integral features of the mounting blocks that capture the capacitor 18 may also be suitable.

In addition, the assembly 10 may include components other than the capacitor 18 that can provide the desired EMI-blocking protection. As one example, the capacitor 18 may be replaced with a ferrite-based device. Other possibilities may also exist.

Those of skill in this art will also recognize that the lead frame 12 may take other configurations known to be suitable for use with NTC sensors.

Moreover, the mounting block 16 may take a different configuration. As one example, the mounting block 16 may be formed as two “halves” that are mated to form the overall mounting block. Such a configuration may enable the mounting block 16 to be molded separately, then applied to the lead frame 12 after molding.

Further in some embodiments, the manufacture of the assembly 10 may follow a different sequence of steps, have additional steps, or omit some steps.

The inclusion of integral capture features (like the latches 50) in the mounting block 16 can simplify the production of the assembly, and can save on both material costs and time.

Some embodiments of the present invention are exemplarily described above in combination with the accompanying drawings. Those of ordinary skill in the art to which the present invention belongs should understand that specific structures shown in the above embodiments are merely exemplary, rather than limiting. Moreover, those of ordinary skill in the art to which the present invention belongs can combine a variety of technical features shown above according to a variety of possible manners to constitute new technical solutions or make other modifications, and these new technical solutions are encompassed within the scope of the present invention.

What is claimed is:

1. A sensor assembly, comprising:
a lead frame comprising a foundation bar and a plurality of tines, the tines extending away from the foundation bar in a first direction;
a plurality of sensors, each of the sensors including a thermistor and a pair of leads, each of the leads in electrical contact with a respective tine of the lead frame, wherein the tines in electrical contact with the leads are adjacent tines;
a plurality of mounting blocks, each mounted to the lead frame to encase a pair of adjacent tines that are in electrical contact with the leads of one of the plurality of sensors, each of the mounting blocks including a pocket;
a plurality of electromagnet interference (EMI)-blocking components, each of the EMI-blocking components mounted in the pocket of a respective one of the mounting blocks and in electrical contact with the tines encased in the mounting block;
wherein each of the mounting blocks includes one or more integral features within the pocket that mechanically capture the capacitive component.

2. The sensor assembly defined in claim 1, wherein the plurality of sensors are negative temperature coefficient (NTC) sensors.

3. The sensor assembly defined in claim 1, wherein the integral features comprise at least one snap-fit latch.

4. The sensor assembly defined in claim 3, wherein the at least one snap-fit latch is two snap-fit latches.

5. The sensor assembly defined in claim 1, wherein each of the plurality of mounting blocks is formed of a polymeric material.

6. The sensor assembly defined in claim 5, wherein each of the plurality of mounting blocks is overmolded onto the lead frame.

7. The sensor assembly defined in claim 1, further comprising a conductive material interposed between the EMI-blocking component and the tines encased in the mounting block.

8. The sensor assembly defined in claim 7, wherein the conductive material comprises conductive epoxy.

9. The sensor assembly defined in claim 1, wherein the EMI-blocking component comprises a capacitor.

10. A method of manufacturing a sensor assembly, comprising the steps of:
(a) providing a lead frame comprising a foundation bar and a plurality of tines, the tines extending away from the foundation bar in a first direction;
(b) molding a mounting block onto the lead frame such that the mounting block encases a portion of two adjacent tines, wherein the mounting block includes a pocket and integral capture features in the pocket;
(c) attaching first and second leads of a sensor to the adjacent tines encased in the mounting blocks; and
(d) inserting an electromagnetic interference (EMI)-blocking component in a pocket in the mounting block, the EMI-blocking component captured by the capture features.

11. The method defined in claim 10, further comprising the step of applying a conductive material between the EMI-blocking component and each of the tines encased in the mounting block.

12. The method defined in claim 10, wherein the sensor is a negative temperature coefficient (NTC) sensor.

13. The method defined in claim 10, wherein the capture feature is at least one snap-fit latch.

14. The method defined in claim 13, wherein the at least one snap-fit latch is two snap-fit latches.

15. The method defined in claim 10, wherein step (d) is carried out via automation.

16. The method defined in claim 10, wherein step (b) is carried via injection molding.

17. The method defined in claim 10, wherein the EMI-blocking component comprises a capacitor.

18. The method defined in claim 10, wherein step (b) precedes step (d).

19. A sensor assembly, comprising:
a lead frame comprising a foundation bar and a plurality of tines, the tines extending away from the foundation bar in a first direction;
a plurality of sensors, each of the sensors including a thermistor and a pair of leads, each of the leads in electrical contact with a respective tine of the lead frame, wherein the tines in electrical contact with the leads are adjacent tines;
a plurality of mounting blocks, each mounted to the lead frame to encase a pair of adjacent tines that are in electrical contact with the leads of one of the plurality of sensors, each of the mounting blocks including a pocket;
a plurality of electromagnet interference (EMI)-blocking components, each of the EMI-blocking components mounted in the pocket of a respective one of the mounting blocks and in electrical contact with the tines encased in the mounting block;
wherein each of the mounting blocks includes one or more snap-fit latches within the pocket that mechanically capture the capacitive component.

20. The sensor assembly defined in claim 19, wherein the at least one snap-fit latch is two snap-fit latches.
